(19) United States
(12) Patent Application Publication
(10) Pub. No.: US 2011/0225096 A1
(43) Pub. Date: Sep. 15, 2011

(54) Method And System For Providing Diagnostic Feedback Based On Diagnostic Data

(76) Inventors: Hanbum Cho, San Jose, CA (US); Sejoong Oh, Oakland Township, MI (US)

(21) Appl. No.: 12/724,418

(22) Filed: Mar. 15, 2010

(51) Int. Cl. G06F 7/00; G06Q 99/00; H04M 1/00

(52) U.S. Cl. 705/305; 701/32; 701/30; 455/556.1

(57) ABSTRACT

A system and method for providing diagnostic feedback based on vehicle diagnostic data is disclosed. According to one embodiment, vehicle data is received from a communication device connected to a motor vehicle. The vehicle data comprises a vehicle identifier and diagnostic data. The diagnostic data is analyzed based on the vehicle identifier. A list of diagnoses is generated based on the analysis. Diagnostic feedback corresponding to the list of diagnoses is transmitted to the communication device. According to one embodiment, the diagnostic feedback is service pricing comprising a list of parts and estimated labor corresponding to the list of diagnoses.

### FIELD

The field of the invention relates generally to an automotive diagnostic system and more particularly relates to a system and method for providing service pricing based on vehicle diagnostic data.

### BACKGROUND

Motor vehicles sold since 1996 in United States are equipped with a diagnostic port known as on-board diagnostic (OBD) II. When an anomaly or an error condition is detected by an in-car module, a check engine light (CEL), also known as a malfunction indicator light (MIL), appears on the dash board of a car. A diagnostic system is connected to the car through the diagnostic port to identify the condition and severity of the error. After a proper repair is done, the diagnostic system is connected to the diagnostic port again to clear the error stored in the module that reported the error. The diagnostic system may also be used for programming in-car modules, store or reset error codes, and change parameters stored in the modules.

In a modern motor vehicle, several in-car modules are connected to a vehicle network such as control area network (CAN) or a manufacturer proprietary network protocol. Those modules are accessible through the diagnostic port. Examples of such in-car modules are engine control unit (ECU), digital motor electronics (DME), vehicle immobilizer, dynamic stability control module, ABS module, heating/air control module, instrument cluster, airbag control module, brake control module, light control module, transmission control module. The overall condition of the car is monitored by these in-car modules and reported to an external diagnostic system via the diagnostic port. Other vehicle condition and status information such as vehicle identification number (VIN), mileage, coolant temperature, wheel speeds, steering angle, engine RPM can be obtained via the diagnostic port as well.

Most car owners do not have a diagnostic system to self diagnose an error after a CEL appears. They have to make a visit to a service provider such as a repair shop or dealership to identify the source and location of the error, and repair if a diagnosis is made. Oftentimes, car owners are reluctant to make a visit to a service provider without knowing the extent of a repair. Some car owners are doubtful about the service charge because the extent of the repair is unknown to them. In many cases, car owners are not given a exhaustive list of parts and labor for the service that they paid for.

Conventional automotive diagnostic and repair processes do not provide satisfaction to the car owners. They do not fully understand if the error code was correctly diagnosed, the repair they received were necessary, and the cost for repair was fair and agreeable. Without understanding the nature and extent of the error and diagnostic details, car owners are rarely satisfied with a service and repair they paid for.

A system described in U.S. Patent Application No. 2009/0313035 provides a method for determining services pricing. A user selects a particular type of a repair/service that he/she would like to get a quote for. The system, at the user's input, provides a range of estimated cost for the user-provided repair/service based on the user's location, manufacturer and model of the user's car. However, the type of service/repair and the resultant service pricing that user receives may be based on his/her own knowledge or other's opinion based on the limited data and symptoms, but not based on the actual error that triggered the error code. This may result in a misdiagnosis, and the user may end up receiving a service/repair that was completely unnecessary.

Therefore, there is a need for a diagnostic system based on real error codes overcoming the aforementioned shortcomings of prior art systems and conventional method of diagnostics and repair/service processes.

### SUMMARY

The present disclosure includes system and method for providing service pricing based on vehicle diagnostic data. According to one embodiment, vehicle data is received from a communication device connected to a motor vehicle. The vehicle data comprises a vehicle identifier and diagnostic data. The diagnostic data is analyzed based on the vehicle identifier. A list of diagnoses is generated based on the analysis. Diagnostic feedback corresponding to the list of diagnoses is transmitted to the communication device. According to one embodiment, the diagnostic feedback is service pricing comprising a list of parts and estimated labor corresponding to the list of diagnoses.

The above and other preferred features, including various novel details of implementation and combination of elements, will now be more particularly described with reference to the accompanying drawings and pointed out in the claims. It will be understood that the particular methods and apparatuses are shown by way of illustration only and not as limitations. As will be understood by those skilled in the art, the principles and features explained herein may be employed in various and numerous embodiments.

### BRIEF DESCRIPTION OF THE DRAWINGS

The accompanying drawings, which are included as part of the present specification, illustrate the presently preferred embodiment of the present invention and together with the general description given above and the detailed description of the preferred embodiment given below serve to explain and teach the principles of the present invention.

FIG. 1 illustrates an exemplary automotive service network, according to one embodiment; and

FIG. 2 illustrates a flow chart for an exemplary statistical analysis, according to one embodiment.

It should be noted that the figures are not necessarily drawn to scale and that elements of structures or functions are generally represented by reference numerals for illustrative purposes throughout the figures. It also should be noted that the figures are only intended to facilitate the description of the various embodiments described herein. The figures do not describe every aspect of the teachings described herein and do not limit the scope of the claims.

### DETAILED DESCRIPTION

A system and method for providing service pricing based on vehicle diagnostic data is disclosed. According to one embodiment, vehicle data is received from a communication device connected to a motor vehicle. The vehicle data comprises a vehicle identifier and diagnostic data. The diagnostic data is analyzed based on the vehicle identifier. A list of diagnoses is generated based on the analysis. Diagnostic feedback corresponding to the list of diagnoses is transmitted to the communication device. According to one embodiment, the diagnostic feedback is service pricing comprising a list of parts and estimated labor corresponding to the list of diagnoses.

In the following description, for purposes of clarity and conciseness of the description, not all of the numerous components shown in the schematic are described. The numerous components are shown in the drawings to provide a person of ordinary skill in the art a thorough enabling disclosure of the present invention. The operation of many of the components would be understood to one skilled in the art.

Each of the additional features and teachings disclosed herein can be utilized separately or in conjunction with other features and teachings to provide the present table game. Representative examples utilizing many of these additional features and teachings, both separately and in combination, are described in further detail with reference to the attached drawings. This detailed description is merely intended to teach a person of skill in the art further details for practicing preferred aspects of the present teachings and is not intended to limit the scope of the claims. Therefore, combinations of features disclosed in the following detailed description may not be necessary to practice the teachings in the broadest sense and are instead taught merely to describe particularly representative examples of the present teachings.

The present invention also relates to apparatus for performing the operations herein. This apparatus may be specially constructed for the required purposes, or it may comprise a general-purpose computer selectively activated or reconfigured by a computer program stored in the computer. Such a computer program may be stored in a computer-readable storage medium, such as, but is not limited to, any type of disk including floppy disks, optical disks, CD-ROMs, and magnetic-optical disks, read-only memories, random access memories, EPROMs, EEPROMs, magnetic or optical cards, or any type of media suitable for storing electronic instructions, and each coupled to a computer system bus.

The methods presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help understand how the present teachings are practiced but are not intended to limit the dimensions and the shapes shown in the examples.

The subject matter described herein relates to a method and system for providing service pricing based on vehicle diagnostic data through a automotive service network (ASN). The status and conditions of a plurality of motor vehicles are obtained and reported to a server in the automotive service network. In order to facilitate data collection and transmission from the plurality of motor vehicles, each motor vehicle is equipped with a diagnostic module. The diagnostic module queries and collects the status and condition of each motor vehicle via a diagnostic port such as on-board diagnostic (OBD) II port.

According to one embodiment, the vehicle status and conditions are reported via a diagnostic port such as OBD II port to a data communication device. In one embodiment, the data communication device is a smart phone such as iPhone® of Apple Computer of Cupertino, Calif., Blackberry® of Research In Motion of Canada. The data communication device may be an in-car communication device capable of sending and/or receiving information to and from an external device. The status and operating conditions of the motor vehicle are transmitted real-time to the external server where the collected data is stored, analyzed, and updated to provide a diagnosis.

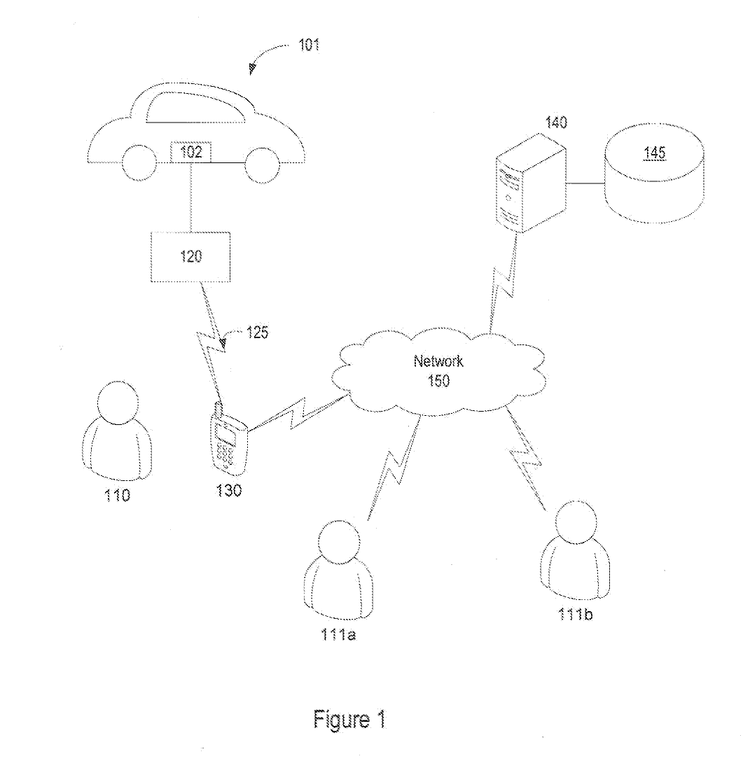

FIG. 1 illustrates an exemplary automotive service network, according to one embodiment. Diagnostic module 120 is connected motor vehicle 101 through diagnostic port 102. Diagnostic module 120 accesses internal modules of motor vehicle 101 and retrieves data such as error codes and vehicle data. Diagnostic module 120 is also connected to communication device 130 to exchange vehicle data with server 140.

In one embodiment, diagnostic module 120 has an internal data communication device. In this case, the communication between diagnostic module 120 and communication device 130 is bypassed, and diagnostic module 120 directly communicates with 140. In another embodiment, diagnostic module 120 is integrated into motor vehicle 101 and is connected with communication device 130 through a wire or wirelessly. It should be noted that the communication protocol between diagnostic module 120 and communication device 130 is beyond the scope of the present subject matter, and any kind of communication protocols may be used without deviating from the scope of the present subject matter.

According to one embodiment, communication device 130 is a smart phone running an application software. The application software receives vehicle data from diagnostic module 120 and transmits to server 140 via network 150. Server 140 receives and analyzes the vehicle data. The results of the analysis is transmitted to communication device 130 such that user 110 reviews analyzed data to stay informed or take appropriate actions when a service or repair is necessary.

Server 140 sends the analyzed data to a plurality of service providers including 111a and 111b. Service providers 111 review the analyzed data, prepare an estimated service pricing. The estimated service pricing information is transmitted to communication device 130. User 110 compares the estimated service pricings from multiple service providers 111.

According to one embodiment, service provider 111 provides the service pricing independently from service provider 111. Possible error codes and the probable causes for each of the possible error codes are identified a priori, and service provider 111 prepares a list of estimates for the probable causes and uploads the list to server 140. The list of estimates are stored in database 145. Upon receiving the vehicle data including an error code, server 140 returns with the service pricing from service provider 111 without contacting service provider 111.

According to one embodiment, diagnostic module 120 is wirelessly connected to communication device 130. For example, diagnostic module 120 is a Kiwi Wifi manufactured by PLX Devices Inc. of Sunnyvale, Calif. or an OBDKey manufactured by KBM Systems Ltd. of United Kingdom.

According to one embodiment, vehicle status is obtained along with a vehicle identifier. For example the vehicle identifier is a vehicle identifier number (VIN) unique to each motor vehicle 101 including information about its make, model, year, month of production, and serial number. Other vehicle specific information may be obtained along with the vehicle identifier, such as mileage information, firmware or software versions, programming parameters of internal modules or control units of motor vehicle 101. These information and data associated with motor vehicle 101 are collectively referred to as vehicle data. According to one embodiment, vehicle data is transmitted to communication device 130, and thereafter to server 140 as encrypted for data integrity and security.

According to one embodiment, vehicle data include one or more error codes of motor vehicle 101. These error codes may be commonly associated with a particular maker, model, and year. For example, an ABS pump error commonly occurs for a Chevrolet Corvette of General Motors after 4 years of production. Server 140 aggregates these error codes collected from many Chevrolet Corvettes. Based on the frequency of the collected error codes commonly occurring to a specific maker, model, year, server 140 performs a statistical analysis to provide user 110 a sense of commonly occurring error for repair of preventive maintenance purpose.

Certain error codes are associated with a specific range of mileage, climate zones, service history, driving habits, or any combination thereof. For example, a certain vehicle model manufactured between certain period is known to develop a particular problem. In these cases, this detailed information is used along with the maker, model, and year information to perform the statistical analysis. Since a specific error code may occur for various reasons, the statistical analysis provides a list of common causes associated with the error code based on many factors and sort them in the order of higher probability.

Certain errors are sensitive the operating temperature of motor vehicle 101. For example, the replacement cycle of a battery is typically shorter in hot weather than colder weather. Rubber bushings or molding deteriorate at a faster rate when exposed to the Sun. Similarly, error codes and conditions greatly vary depending on operating conditions, so it would be difficult to identify common causes of an error code in a conventional manner. The present system and method allows for more accurate and predictable diagnosis of causes of errors based on statistical analysis to help car owners and mechanics to take an educated guess in a statistical manner.

Common causes of these errors may be aging or failed parts. Server 140 stores manufacture recommended cycle times for these parts and gives a heavier weight when the recommended cycle time approaches. If the vehicle history for a particular motor vehicle 101 identifies that a service was done, a lower weight is given when calculating the probability caused by these parts. If the same error occurs within a certain period of time after the service, it is likely that the installation of the part may not have been done, thus increasing the weight factor for the analysis.

The higher the volume of these collected diagnostic data and reference data, the higher the chance of correctly identifying the reported error code. A particular error may be closely or remotely related to a known problem. The vehicle owner, when an error code appears, obtains this statistical information about the error code to understand the nature and likelihood of the error and decide the next course of action based on the list of probable causes provided by server 140.

According to one embodiment, communication device 130 performs a statistical analysis. Reference data is received from server 140 and stored in a storage of communication device 130. The reference data contains information about an error code, such as probable causes of the error code. Server 140 periodically updates field data to the storage of communication device 130. The field data contains information specific to a manufacturer, model, and year of a target vehicle. The application software running on communicate device 130 performs an analysis based on the reference data and field data. The result of the analysis including a list of probable causes is sent to service providers 111 directly. Other users who do not have diagnostic module 120 and/or communication device 130 may connect to server 140 via network 150 to review statistical results on certain maker, model, and year. For a specific error code, those users can still be benefited even if a diagnosis may be done independently.

For example, an OBD II error code P0171 indicating that the system is running too lean at bank 1, appears on the dash board. The vehicle data containing this error code is transmitted to server 140 by user 110's smart phone 130.

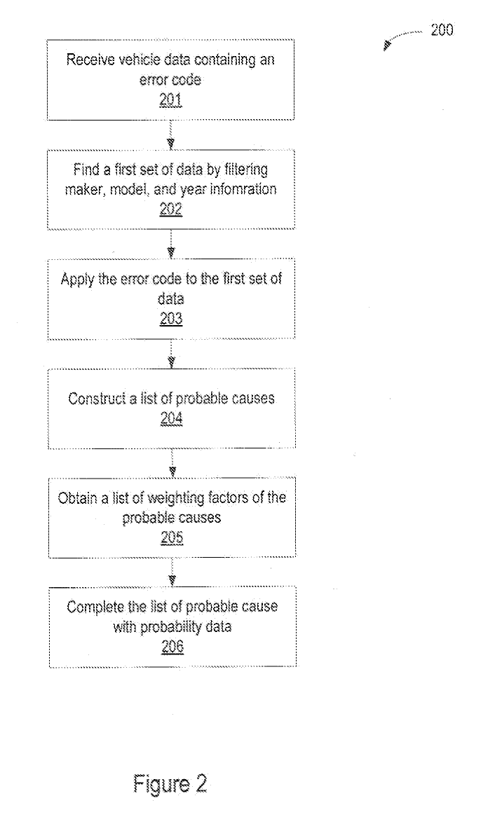

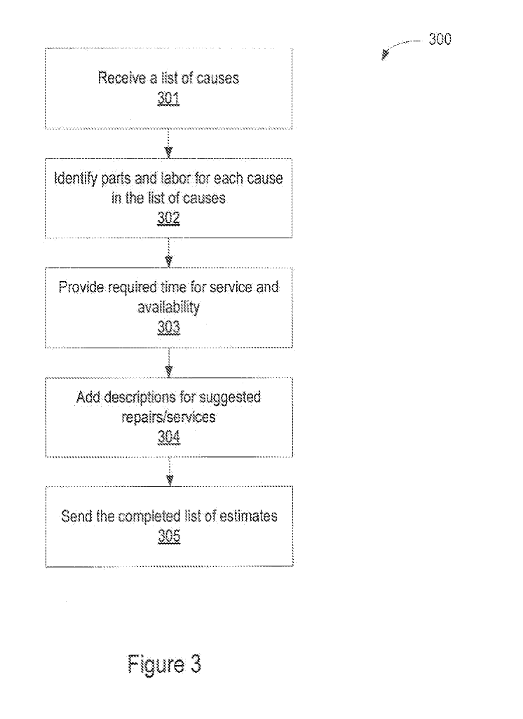

FIG. 2 illustrates a flow chart for an exemplary statistical analysis, according to one embodiment. Server 140 receives vehicle data containing an error code (201). The maker, model, and year information is extracted from vehicle data to find a first set of data from the corresponding reference data and field data (202). The error code contained in the vehicle data is applied to the first set of data (203). The reference data stored in database 145 is searched to find a match with the error code. A list of probable causes associated with the error code is constructed, namely Xᵢ, where i=1 to n, n being the total number of probable causes (204). The field data stored in database 145 is searched to find a respective weighting factor of each of the probable causes, namely as identified in step 203 (205). The field data may be applied using the service history and other operating conditions related to the particular motor vehicle 101. Based on the list of the probable causes and weight factors, a list of probability is constructed (206) as shown in Table 1 below. For example, the overall probability Pᵢ of a probable cause i is calculated by:

Pi=aᵢ*Xᵢ.

Identified probable causes Pi are sorted in the order of highest probability. This completed list of probable causes is sent to service providers 111 through network 150.

FIG. 3 illustrates a flow chart for an exemplary service pricing process, according to one embodiment. Service provider 111 receives a list of causes from server 140. For each cause in the list, service provider 111 identifies the extent of a required service including a list of parts including the numbers and price, and an estimated labor charge (302). Service provider 111 may have a list of completed estimates for commonly occurring errors such that the list may not have to be prepared each time. For user 110's convenience, service provider 111 also provide an estimate time for the service, and the available time slot (303). Service provider 111 identifies additional information to attract user 110 such as specials, discounts, combination deals, etc. (304). For a certain type of repair, it is less costly to replace other parts as a preventive maintenance. If the servicing time approaches, service provider 111 may offer a package deal to user 110. The detailed description about the additional service may be provided to educate user 110 with a complete broken down exhaust list of parts and labor. The completed list of estimates is sent to user 110 (305). User 110 reviews multiple estimates and compares the offerings from multiple service providers 111.

The present system and method helps user 110 to obtain detailed information about an error code and multiple options for a service/repair based on the real vehicle data. The statistical analysis performed on the vehicle data provides the best educated guess since there is no exact single reason for an error. The statistical analysis considers severity of the error code, as well as the frequency of them. The statistical analysis may further reference to the mileage information and the service history of motor vehicle 101 to accurately propose probable causes of the error and the corresponding services and repair. In one embodiment, the error code is automatically transmitted to server 140 without user 110's interruption if so programmed. Server 140 informs user 110 of the analysis result in a predefined manner, such as a voice message, an email, or a twitter log, etc. Similarly, service provider 111 may provide service estimates in a preferred method of communication.

The following table shows an exemplary list of causes associated with error code P0171.

TABLE 1

| | Frequency | | | |
|---|---|---|---|---|
| Cause | (Probability) | Parts | Labor | Total |
| Crack in the intake | 60% | $30 (OEM Intake | $70 | $100 |
| boot | | tube) | | |
| Failing mass air flow | 20% | $300 (OEM MAF | $100 | $400 |
| sensor | | sensor) | | |
| Failing Oil Separator | 15% | $400 (OEM oil | $450 | $850 |
| | | separator) | | |
| Failing Oil Separator | 3% | $40 (OEM oil | $300 | $340 |
| tube only | | separator tube) | | |
| Failing spark plugs | 2% | $50 (6 spark plugs, | $200 | $250 |
| | | Bosch Iridium) | | |

There may be many probable causes to trigger an error code. For example, P0171, system too lean at bank 1, may be caused by a crack in the intake boot, failing spark plug, mass flow sensor or a throttle body, or a failing oil separator.

The statistical analysis on this error code reveals that which causes of the many causes most probable. In the above example of Table 1, a crack in the intake boot is reported to be a 60% of chance of the error code, failing mass flow sensor 20%, a clogged oil separator 15%, and throttle body 3%, etc. User 110 reviews the list along with frequency or probability of the cause based on the information stored in database 145 of server 140 and determines which option to choose.

In one embodiment, service provider 111 reviews the list of probable causes and edits it to provide repair options and pricing to the users. Experienced mechanic may further refine the data in the list to enhance the chance of correct diagnosis. The reference data and field data for running a statistical analysis may be collected automatically as more analyses are being done, or obtained by inputs from users 110, service providers 111, or survey data.

The list of estimates is particularly useful when the user plans for a repair. Some users would feel more comfortable when they have several options for the repair. These options further provide detailed and broken-down list of the repair including parts and estimated labor. Some users may choose to repair the most probable cause, whereas other users may choose to repair the least expensive cause of the error and select service provider 111 accordingly. After correctly identifying the correct cause of the error, user 111 may leave a feedback to help refining the statistical model.

According one embodiment, service provider 111 provides user 110 with a good-faith estimate based on an error code. The present automotive service network provides a platform for mutual communication based on real vehicle data. Service providers 111 provide a good-faith estimate including the type of work, the parts to be replaced, fixed, or rebuilt, and the associated labor. In the above-described example, a repair estimate from service provider 111 for replacing an intake boot is $100 including $30 of part and $70 or labor. The repair estimate for a mass air flow sensor is $400 including $300 part and $100 labor. This is particularly advantageous over any prior art service pricing system where user 110 is required to identify a cause of en error by reading the error code or taking a guess. Users 110 who are not familiar with vehicle diagnostics or service/repair processes are discouraged from using these conventional service pricing systems.

According to one embodiment, the present automotive service network provides a platform for multiple bidding for a certain type of repair/service associated with an error code. The multiple bidding system is more valuable to users 110 as well as service providers 111 because it is based on a good-faith estimate system. For example, repair shop A bids $100 of the intake boot repair, whereas repair shop B bids for $90 for the same repair. Without understanding which parts and services are included in these pricing, user may be fooled by the cheaper estimate. This problem is eliminated, or at least mitigated because user 110 reviews actual biddings including the detailed description of the service and repair. Based on these good-faith estimates, user 110 chooses the best option. After the service/repair is done, users 110 leave a positive or negative feedback based on the service they received. This feedback information is used to refine the statistical model where more reputable service providers 111 may be given a priority.

Oftentimes, multiple error codes appear simultaneously. By monitoring the vehicle status real-time, the appearance of simultaneously occurred errors or a new error can be determined. Occurrence of multiple error codes can be used to better determine the root cause of the problem. A combination of error codes further refines a candidate list of the cause because such a combination can be caused by only from a partial list of the causes. For example, P0171 and P0172 appear simultaneously. In this case, both bank 1 and 2 are too lean, implying that the problem is on both bank 1 and 2, not only bank 1 or bank 2. In this case, failing spark plug is ranked lower in the list because the likelihood of having at least one bad spark plug in bank 1 and bank 2 are lower, if not impossible.

According to one embodiment, the present system and method is applied for a dealer network. Users 110 receiving service and repair at a dealership are offered to install a diagnostic module 120 in their cars. The diagnostic module 120 connects to user 110's smart phone 130 to retrieve vehicle status and send it to server 140. The dealership may receive vehicle data from server 140 or runs server 140 in their network. The dealership may send a promotion or a service reminder, a discount coupon to encourage users 110 to visit for a repair or service.

Diagnostic module 120 may be securely connected to smart phone 130 running an application thereon. In order to provide a further incentive for the customer to return to the same dealership, diagnostic module 120 is programmed to work with only the designated application. In one embodiment, the vehicle identification code and/or the mileage information are used to verify the ownership of diagnostic module 120. Only the verified vehicle status data are transmitted to server 140.

According to one embodiment, user 110 receives a location-based reminder for a service. The GPS of user 110's smart phone 130 identifies the nearby service provider 111 and their specialty in servicing a particular error code. The location-based reminder service provides convenience and case for a casual repair or service.

According to one embodiment, the present system and method is used for programming firmware or software of an in-car module. In this case, a diagnostic analysis of error codes may not be necessary. The programming process starts with a transmission of a program by the server to the communication device. The communication device stores the programs and notifies the user. The user determines when to perform the update. Programming an in-car module may require a steady source of power from an external power source. The diagnostic module is connected to the external power source to perform the updates. The communication device stores the current version and/or the updated version of the program. When the update fails, the user can restore the current version or try to install the updated version.

A method and system for providing service pricing based on vehicle diagnostic data is disclosed. Although various embodiments have been described with respect to specific examples and subsystems, it will be apparent to those of ordinary skill in the art that the concepts disclosed herein are not limited to these specific examples or subsystems but extends to other embodiments as well. Included within the scope of these concepts are all of these other embodiments as specified in the claims that follow.

1. A method for providing diagnostic feedback comprising:
receiving vehicle data from a portable communication device connected to a diagnostic module, wherein the diagnostic module is connected to a diagnostic port of a road vehicle equipped with the diagnostic port, and wherein the vehicle data is retrieved by the diagnostic module from the road vehicle without human interruption at a request of the communication device, and the vehicle data comprises a vehicle identifier and diagnostic data;
performing an analysis on the diagnostic data based on the vehicle identifier;
generating a list of diagnoses based on the analysis; and
transmitting the diagnostic feedback corresponding to the list of diagnoses to the portable communication device.

2. The method of claim 1 further comprising:
providing the list of diagnoses to a service provider; and
receiving the diagnostic feedback from the service provider.

3. The method of claim 2, wherein the diagnostic feedback comprises service pricing, and the service pricing comprises a list of parts and estimated labor cost corresponding to each of the list of diagnoses.

4. The method of claim 1, wherein the vehicle identifier comprises manufacturer and model, and year information of the road vehicle.

5. The method of claim 1, wherein the portable communication device is a smart phone running an application.

6. The method of claim 1, wherein the diagnostic port is an on-board diagnostic (OBD) II port.

7. The method of claim 1, wherein the diagnostic data comprise an error code.

8. The method of claim 7, wherein the list of diagnoses comprises probable causes of the error code.

9. The method of claim 7, the diagnostic feedback is a control command to reset the error code.

10. The method of claim 7, the diagnostic feedback is a control command for programming in-car modules of the road vehicle.

11. The method of claim 3, wherein the service pricing comprises a list of service and/or repair corresponding to each of the list of diagnoses.

12. The method of claim 3 further comprising:
providing the list of diagnoses corresponding the diagnostic data to a second service provider;
receiving a second service pricing from the second service provider, the second service pricing identifying a list of parts and estimated labor cost corresponding to list of diagnoses; and
transmitting the second service pricing to the portable communication device.

13. The method of claim 12 further comprising:
comparing the service pricing with the second service pricing.

14. The method of claim 1, wherein
the analysis is a statistical analysis performed on an error code contained in the diagnostic data based on manufacturer, model, and year of the road vehicle.

15. The method of claim 14, wherein the list of diagnoses is provided in an order of probability based on the statistical analysis.

16. The method of claim 1 further comprising:
storing diagnostic history specific to the road vehicle in a database; and
performing the analysis based on the diagnostic history.

17. The method of claim 8 further comprising:
storing reference data corresponding to a plurality of error codes in a database;
storing field data specific to the manufacturer and model and year information of the road vehicle in the database; and
performing the analysis based on the reference data and the field data.

18. The method of claim 17, wherein the list of diagnoses is obtained from the reference data corresponding to the error code received from the road vehicle.

19. The method of claim 18, wherein each of the probable causes is calculated by a weighting function having a weighting factor, and wherein the weighting factor is calculated based on the field data.

20. The method of claim 1, wherein the vehicle data is retrieved by the diagnostic module as the diagnostic data changes.
